(19) United States
(12) Patent Application Publication
(10) Pub. No.: US 2005/0083274 A1
(43) Pub. Date: Apr. 21, 2005

(54) Sub-pulse width modulation for gamma correction and dimming control

(76) Inventors: Aaron Beddes, Mendon, UT (US); Robert Barson, Hyde Park, UT (US); Milo Whitehead, Hyrum, UT (US)

Correspondence Address: PITNEY HARDIN LLP, 7 TIMES SQUARE, NEW YORK, NY, 10036-7311, US

(21) Appl. No.: 10/630,495

(22) Filed: Jul. 30, 2003

(51) Int. Cl. G09G 3/32

(52) U.S. Cl. 345/82

(57) ABSTRACT

The method and apparatus uses pulse-width-modulation to drive display elements, such as light emitting diodes, within an active matrix display. At least one of the shift cycles is a sub-pulse-width-modulation cycle in which the display is disabled for a fraction of the shift cycle. This provides an increased number of possible display colors for the display elements. Additionally, the display can be disabled for some portion of the remaining shift cycles in order to provide a dimming of the display without losing color resolution.

### BACKGROUND OF THE INVENTION

1. Field of the Invention

The present invention relates to an apparatus and method for gamma correction and dimming control, particularly in an active matrix electronic display which uses LEDs (light emitting diodes).

2. Description of the Prior Art

In the prior art, the use of light emitting diodes (LEDs) for creating active matrix electronics displays is known. Such electronic displays are used in a wide variety of applications including roadside message centers and marquees, sports scoreboards and scoring matrices, and full color video displays.

Most of these electronic displays vary the brightness of the LEDs to achieve shades of a single color. Similarly, full color displays vary the brightness of the LEDs to achieve a substantially complete spectrum of colors. Because of the nonlinear properties of LEDs, it is impractical to vary the intensity of the output of the LEDs by varying the strength with which the LEDs are driven. Rather, the intensity of the LED is fixed at an upper limit, and then the amount of time for which the LED is turned on is varied in order to achieve a spectrum or range of shades or colors. This scheme of turning on and turning off an LED or similar display device at a specified rate is called pulse-width-modulation. It is typically done fast enough so that the human eye cannot detect the resulting flicker and is instead fooled into believing that the intensity of the LED is changing.

Several microchip manufacturers produce integrated circuits that are tailored to help display manufacturers drive LEDs in a pulse-width-modulation scheme. The most basic and most widely used of these ICs allow binary data to be transparently shifted serially into shift registers, latched into place at a specified time, and asserted on the output of the chip to the LED. These chips are commonly known as “constant current driving shift registers or just “constant current drivers”. FIG. 1 is a simplified diagram of these prior art chips.

The human eye perceives light intensity on a non-linear scale. The human eye is much more sensitive to changes in intensity at low light levels, and much less sensitive to changes in intensity at high light levels. This sensitivity allows humans to see just as easily indoors in artificial lighting as outdoors in sunlight, which is several orders of magnitude more intense.

However, this nonlinear perception creates a problem when capturing images and reproducing them digitally. To perceive small changes in light intensity at low levels, a very fine granularity on both the capture side and the display side of a system is required. Most people are unable to detect more than 256 shades of any one color. To represent these 256 shades digitally, an 8-bit number is assigned to each color component (for instance, red, green and blue) of each pixel. When a greater number of bits is used, for instance, in a scanner, the extra input resolution is used to achieve a finer granularity on the low end of the intensity spectrum. When the data is finally transferred to a computer, all of the bits are used to produce only a few colors, and typically over eighty percent of the 256 shades are produced with only 4 to 8 bits.

The curve along which the actual shades are translated to what the human eye perceives as linearly incremented shades is called the gamma curve. An example of a gamma curve is shown in FIG. 2. The process of translating between actual and perceived intensity is called gamma correction.

Many electronic displays are installed in outdoor environments where the ambient light levels range from the absolute brightest at midday, to absolute dimmest in the middle of the night. As ambient light levels change, the human eye adjusts to allow less or more light to enter.

Electronic displays are designed and built to be bright enough to run in the brightest of situations in which the display will be used. As the human eye adjusts to a dimmer ambient light, such as at night, a sign or display running at one hundred percent brightness would be very distracting and uncomfortable to view. For this reason, electronic displays are required to dim to adjust to all possible light levels.

In electronic displays, the data clock provides a limit to the speed at which data can be shifted serially into constant current drivers. Typically, the upper limit on the data clock is between ten to twenty million cycles per second (10 MHz-20 MHz). Using this clock frequency, the rate at which new frames are displayed or repeated, and the length of the serial chain through which data is shifted, the calculation of the total number of shades that can be displayed is straightforward. For example, if the data clock rate is 10 MHz, the length of the data chain is 256, and the frame refresh rate is 150 times per second, then the total number of times that the LEDs can be turned on and off (i.e., modulated) during one refresh cycle is: 10,000,000/(256*150)=260.

Recalling that digital color is typically represented by an 8-bit number with 256 possible values, this may initially appear to be adequate. However, in order to achieve gamma correction, a much higher number of linear shades are required to achieve a pleasing display. For example, using a gamma curve factor of 2.5 and using 16 bits to represent the gamma corrected colors still doesn't provide for a unique gamma corrected output shade for each input shade. Assuming 16 gamma corrected bits, the first uncorrected shades of 0, 1, 2, 3 and 4 would have to be rounded and assigned to 0, 0, 0, 1 and 2, respectively. Moreover, beyond the consideration of effective gamma correction, some applications may require that the display be dimmed in low light environments. Dimming is typically achieved by reducing the available color palette to one half, or even one quarter of the original size at the low end of the spectrum, thereby exacerbating the deficiencies with respect to granularity.

### OBJECTS AND SUMMARY OF THF INVENTION

It is therefore an object of the present invention to provide additional color resolution in an electronic display which uses pulse-width-modulation to control the apparent shade and brightness of the display, particularly displays which use LEDs and constant current drivers.

It is therefore a further object of this invention to provide additional color resolution in an electronic display to provide the granularity required for more effective gamma correction and dimming.

It is therefore a still further object of the present invention to achieve the above objects without requiring additional clock speed or a substantial increase in cost or complexity of the display and associated electronics.

These and other objects are attained by providing a method and apparatus for pulse-width-modulation in an electronic display wherein one of the shift cycles is assigned to a sub-pulse-width bit. During this shift cycle, data is shifted to all registers and latched. At typically one-half shift cycle's time later, the entire display is disabled for the remainder of the shift cycle. This disabling is accomplished by adding logic to the circuitry which drives the enable line of the constant current driver. This allows any of the LEDs to be turned on for half of a shift cycle, or what in the prior art was an indivisible amount of time for a given data clock speed. By organizing the gamma correction assignments to take advantage of this possible fractional on-time, the number of shades which it is possible to display is nearly doubled. A simplified example is that if 17 shades are available without the sub-pulse-width bit and associated circuitry (all integers between 0-16 inclusive), then 32 shades are available with the sub-pulse-width bit and associated circuitry (0, 0.5, 1.0, 1.5 . . . 15.5). Similarly, another shift cycle can be assigned a one quarter or similar value to again nearly double the number of shades available. While there is some loss in brightness due to this configuration, this loss is negligible in view of the high number of shift cycles, such as 1024, that are typically used. Moreover, the number of LED pixels which are required to reach maximum brightness in any one frame is usually low.

Additionally, the sub-pulse-width-modulation can be used to dim a display without sacrificing the range of possible colors. The enable line can be used to vary the amount of time that the display is enabled during each half cycle, thereby dimming the sign without reducing the number of shades available to be displayed by the sign.

### BRIEF DESCRIPTION OF THE DRAWINGS

Further objects and advantages of the invention will become apparent from the following description and claims, and from the accompanying drawings, wherein:

FIG. 1 is a schematic of a constant current driving shift register of the prior art.

FIG. 2 is a typical gamma curve.

FIG. 3 is a simplified timing diagram illustrating the use of the present invention for gamma correction in an electronic matrix display, wherein sub-pulse-width-modulation is used in a single shift cycle.

FIG. 4 is a simplified timing diagram illustrating the use of the present invention for gamma correction and dimming in an electronic matrix display, wherein sub-pulse-width-modulation is used in all shift cycles.

FIG. 5 is a schematic of the output side of the modulator card used to implement the present invention, along with the active matrix electronic display.

FIG. 6 is a schematic of the logic for dimming an active matrix electronic display in the present invention.

FIG. 7 is a schematic of the logic for brightness modulation of an active matrix electronic display in the present invention.

FIG. 8a is a timing diagram of the inputs to the logic of FIG. 6.

Figure 8b is the timing diagram of FIG. 8a, but in greater detail over a shorter period of time.

FIG. 9 is a timing diagram of the inputs to and outputs from the logic of FIG. 7.

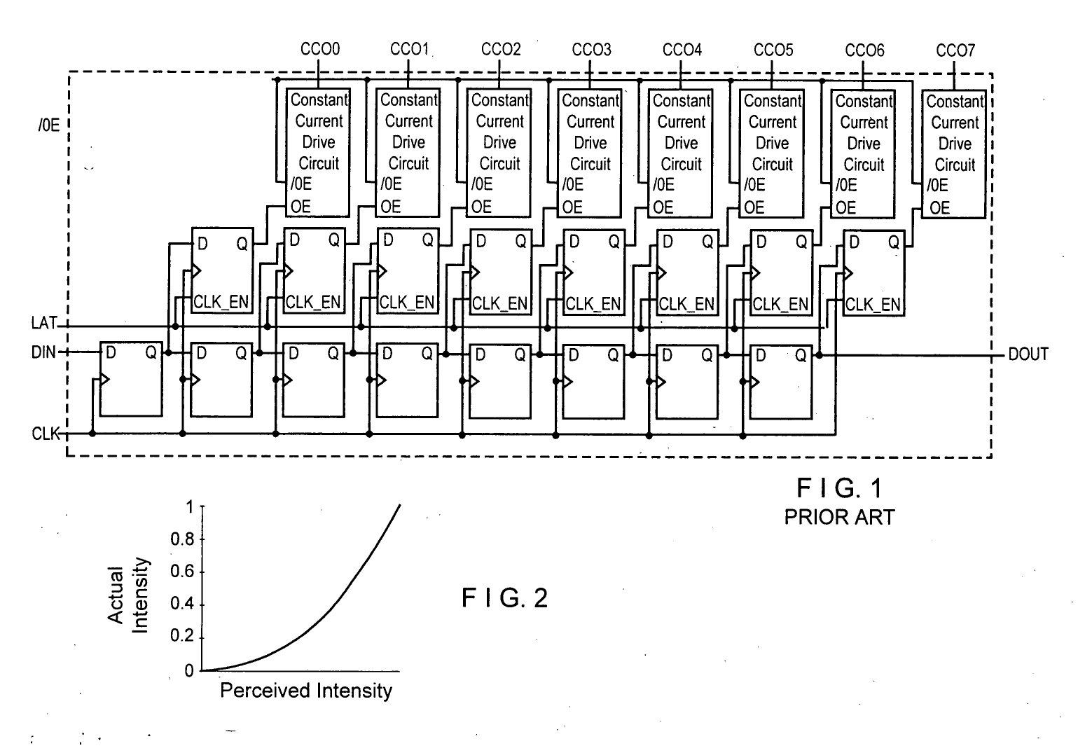

### DETAILED DESCRIPTION OF THE PREFERRED EMBODIMENT

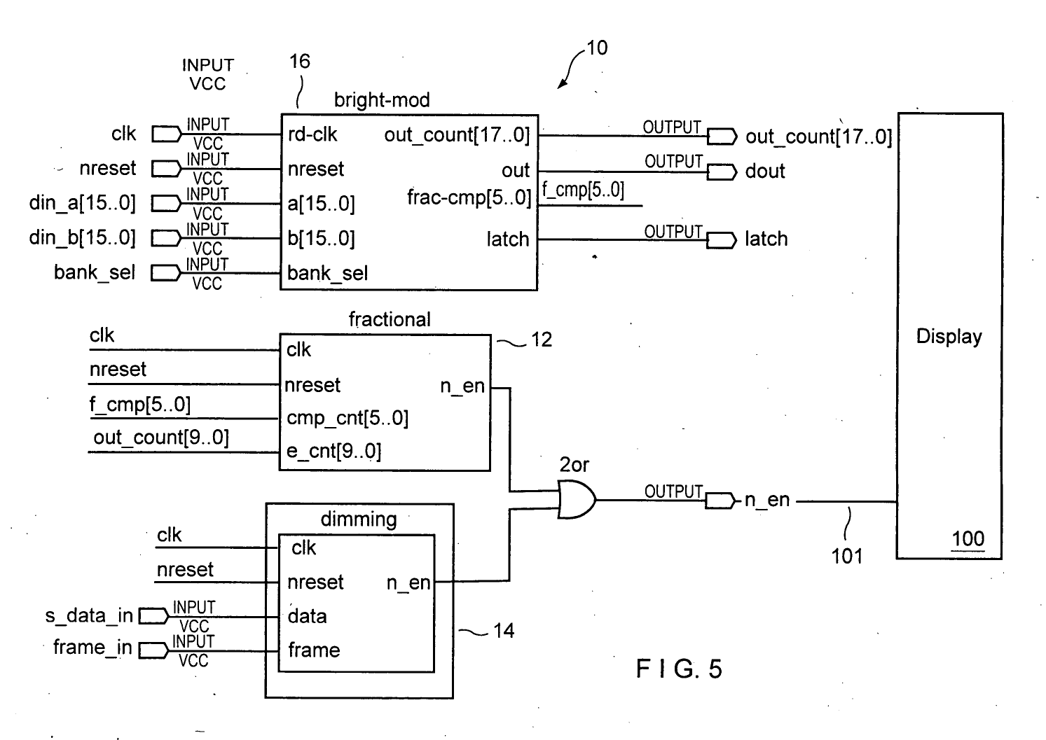

Referring now to the drawings in detail wherein like numerals indicate like elements throughout the several views, one sees that FIG. 5 is a schematic of the output side of the modulator card 10 used to implement the present invention, along with the active matrix electronic display 100.

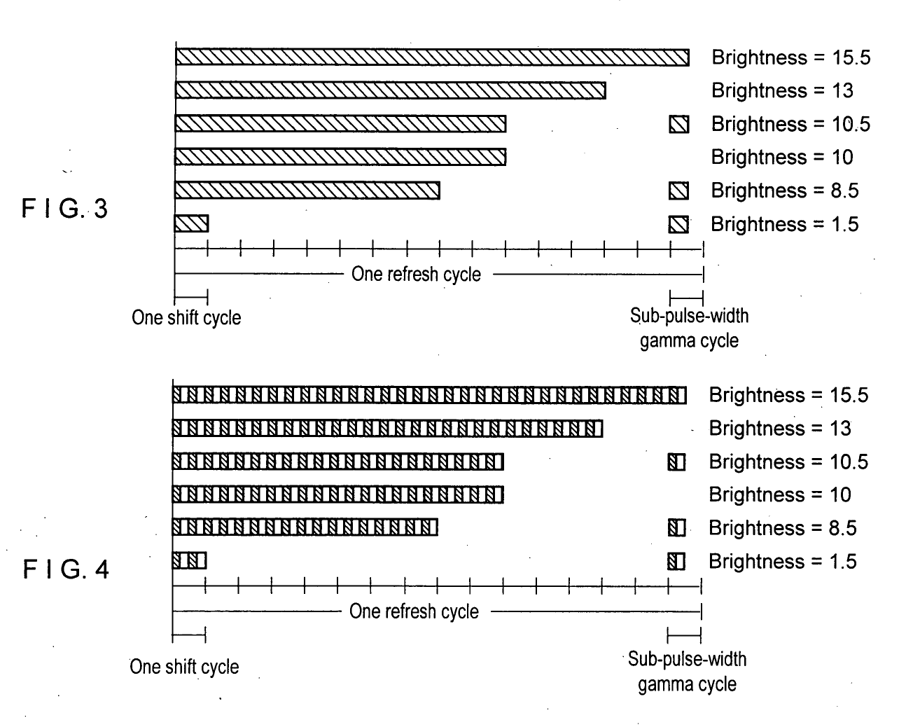

Modulator card 10 is configured to drive the active matrix electronic display in a pulse-width-modulation configuration wherein binary data is transparently shifted serially into shift registers, latched into place at a specified time, and asserted on the output of the chip to the LED. However, the pulse-width-modulation is modified from the typical prior art configuration of simply dividing the refresh cycle into several identical shift cycles and activating the LEDs with a constant current for some integer number of shift cycles during the refresh cycle-Rather, to achieve an increased number of possible colors or shades to increase the pallet available for gamma correction, as shown in FIG. 3, at least one of the shift cycles is turned into a sub-pulse-width gamma cycle wherein any LED of the active matrix electronic display can be activated, or not, for only a portion of the shift cycle. This is accomplished by disabling the entire display 100 via the negative-enable line 101 of the display for some fraction of a shift cycle, illustrated as the second half of the final or rightmost shift cycle in FIG. 3. In the illustration of FIG. 3, with 16 shift cycles in a refresh cycle, this allows any individual LED to be activated for an integer number of shift cycles (other than 16), such as 13 shift cycles (see second example from top) or ten shift cycles (see fourth example from the top) during a refresh cycle. Additionally, however, this allows any individual LED to be activated for an integer number plus one half shift cycles during a refresh cycle. Examples of these values are illustrated in FIG. 3 as 15.5, 10.5, 8.5 and 1.5. Additionally, it is fully contemplated in this invention that a subset of shift cycles including more than one shift cycle during a refresh cycle could be sub-pulse-width-modulation gamma cycles. For instance, an additional sub-pulse-width-modulation gamma cycle could disable the display for three quarters of the shift cycle thereby providing a period of time of one quarter shift cycle for possible activation of any LED. This, in combination with the sub-pulse-width-modulation gamma cycle described above wherein the display is disabled for one half cycle, would permit brightnesses corresponding to integer numbers of refresh cycles, integer numbers plus one quarter refresh cycles, integer numbers plus one half refresh cycles, and integer numbers plus three quarters refresh cycles. Those skilled in the art, after review of the above, will realize that further finer gradations are possible.

Similarly, as shown in FIG. 4, the sub-pulse-width-modulation gamma cycle can be divided into one on-off cycle and all remaining shift cycles of a refresh cycle can be subdivided into two on-off cycles (each on-off cycle comprising half of a shift cycle), so that the sub-pulse-width-modulation can be used to dim a display without sacrificing the range of possible colors. The enable line can be used to vary the amount of time that the display is enabled during each half shift cycle (that is, varying the proportion of “on” to “off” during each on-off cycle which, in total, comprises half of a shift cycle), thereby dimming the sign without reducing the number of shades available to be displayed by the sign.

Referring back to FIG. 5, the timing for the negative enable line for the sub-pulse-width-modulation for gamma correction is performed by fractional block 12 while the timing for the negative enable line for the sub-pulse-width-modulation for dimming is performing by dimming block 14. The outputs of fractional block 12 and dimming block 14 are input to OR-gate 16, the output of which is input to the negative enable line 101 of display 100.

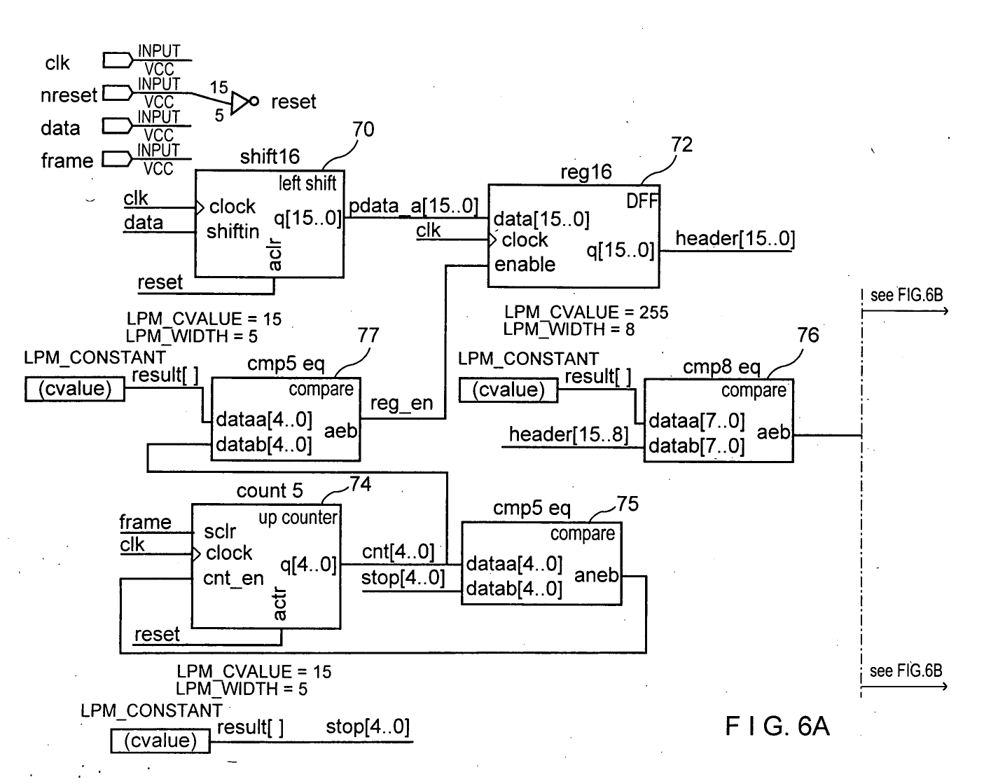

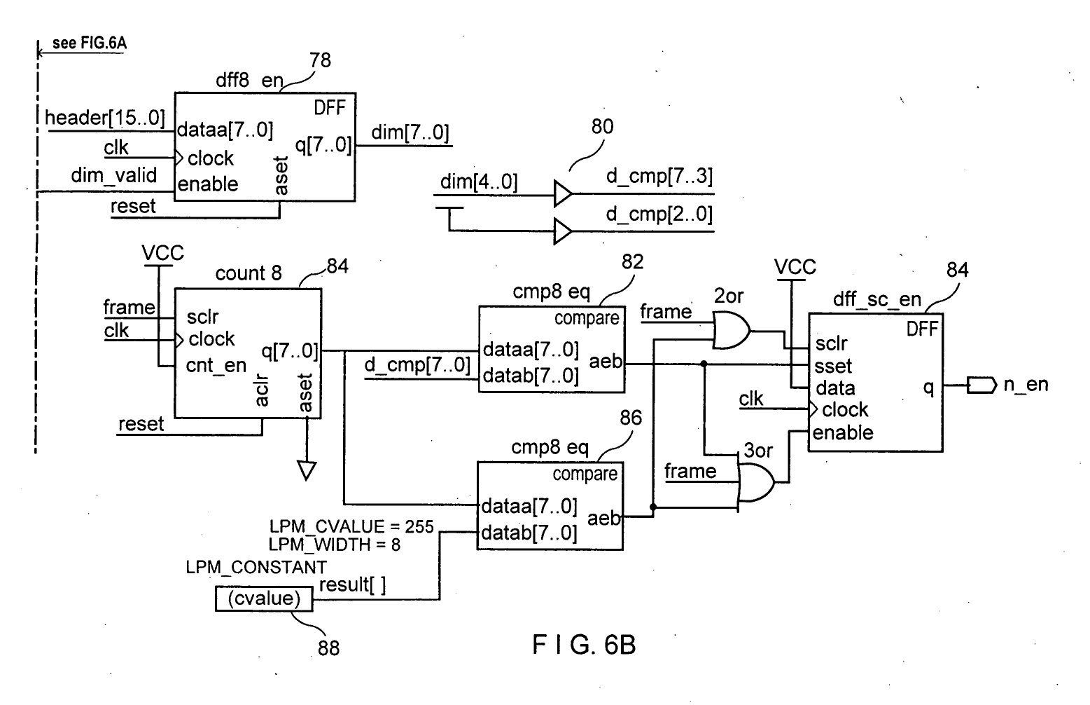

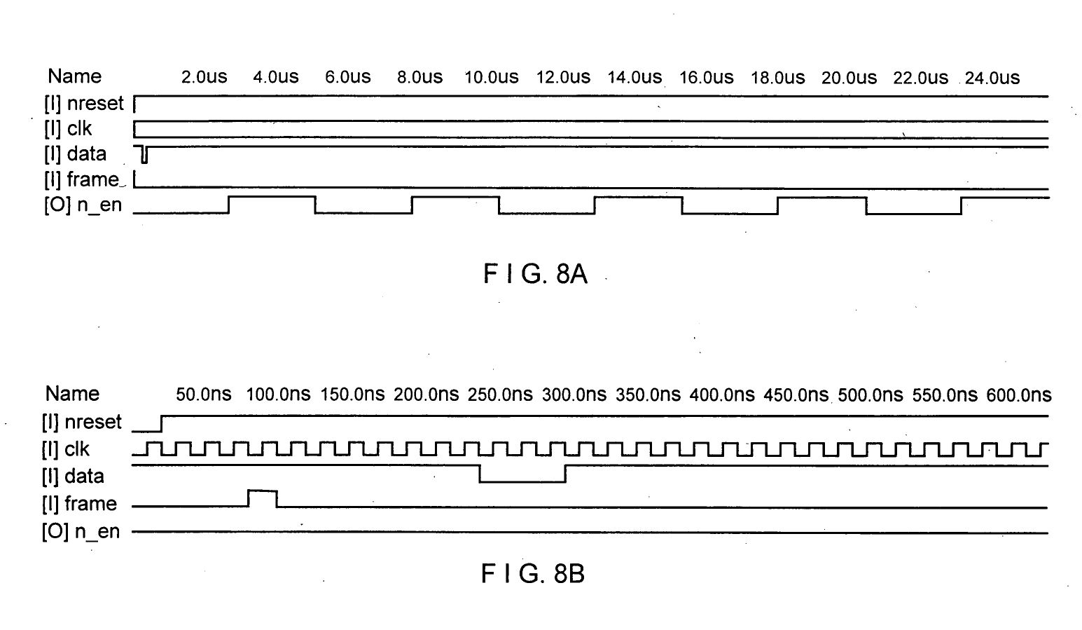

The dimming block 14 is illustrated in more detail in FIG. 6 with the input/output signals to dimming block 14 shown in the timing diagrams of FIGS. 8a and 8b which illustrate:
“nreset” is the negatively asserted reset line;
“clk” is the data clock;
“data” is the serial data stream, which includes a 16-bit header with brightness information, followed by the raw color information;
“frame” indicates the start of a new frame; and
“n_en” is a negatively asserted enable line (output signal, see right side of FIG. 6).

The signal “nreset” needs to be asserted once on power-up to put the module in a known initial state (such as counters at zero, flip-flops set or cleared, and other states that would be known to one of ordinary skill in the art after review of this disclosure).

The first 16 bits received on the data line coinciding with, and immediately following, the assertion of the “frame” signal are captured and stored using shift register 70 and then parallel load register 72. In other words, the data line is used to serially transfer pixel color information, except that the first 16 bits after a “frame” signal are a header. The serial data is continually shifted through the 16-bit shift register 70. The “frame” signal causes the reset of 5-bit counter 74. The output (cnt(4 . . . 0)) of 5-bit counter 74 goes to the input of comparators 75 and 77. The second input of comparator 77 is a constant value of 15. When the output of 5-bit counter 74 reaches 15, the output (reg_en) of comparator 77 is enabled, which is input to the register enable input of parallel load register 72 thereby causing the data in shift register 70 (which has a parallel output) to be latched into the parallel load register 72. The upper byte is checked by comparator 7S to make sure that the header is a “dimming information” header (the upper byte is typically “0xFF”, the lower byte is typically the dimming byte). If so, the lower byte is registered into a permanent 8-bit flip flop 78 that is used to store the dimming byte.

As the output dimming byte (dim(7 . . . 0)) from flip-flop 78 contains only five bits of dimming information, block 80 transfers or shifts these five bits to the most significant bits with the three least significant bits being set to the value of “1”.

Compare module 82 receives the reconfigured output dimming byte (dim(7 . . . 0)) from block 80 and further receives an input from free running 8-bit counter 84. When the 8-bit counter 84 reaches the same value as the output dimming byte, the output of compare module 82 goes high and flip flop 84 is synchronously set. This disables all LED driver chips via the n_en line. When the 8-bit counter 84 reaches 255, as determined by compare module 86 which receives the output from counter 84 as a first input and a constant value of 255 from block 88 as a second input, flip flop 84 is synchronously cleared via the “sclr” input thereby re-enabling all LED driver chips. This sequence results in the pulse-width-modulation or sub-pulse-width-modulation of the n_en line.

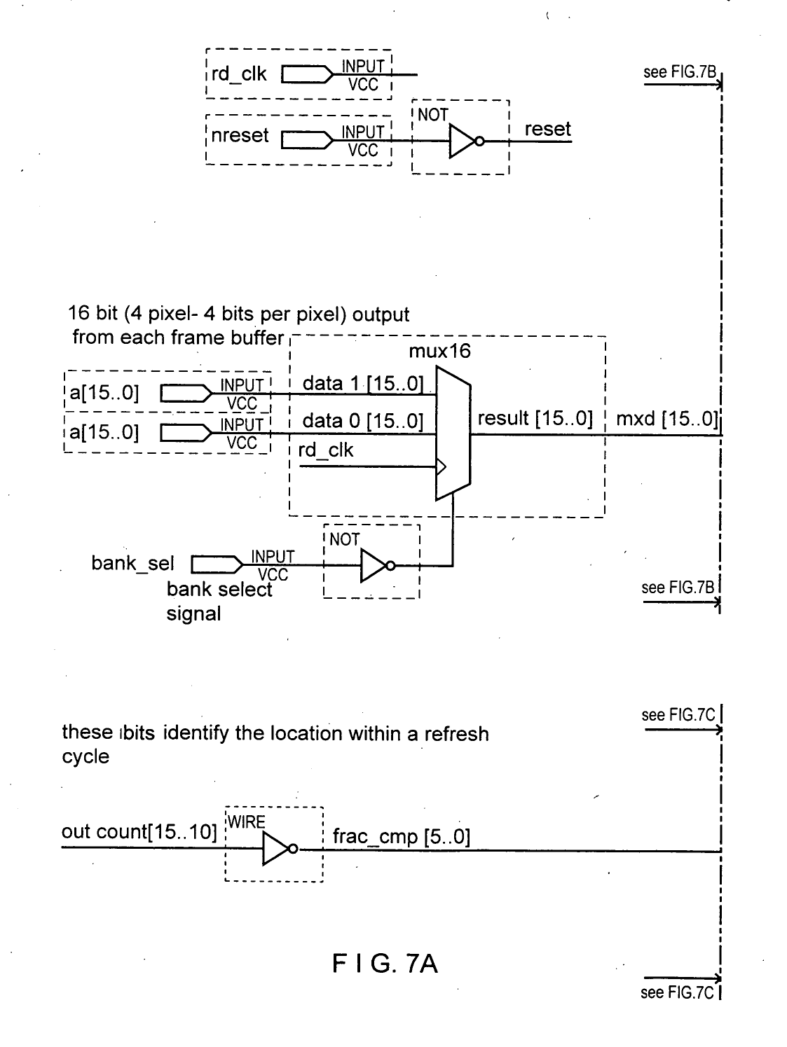

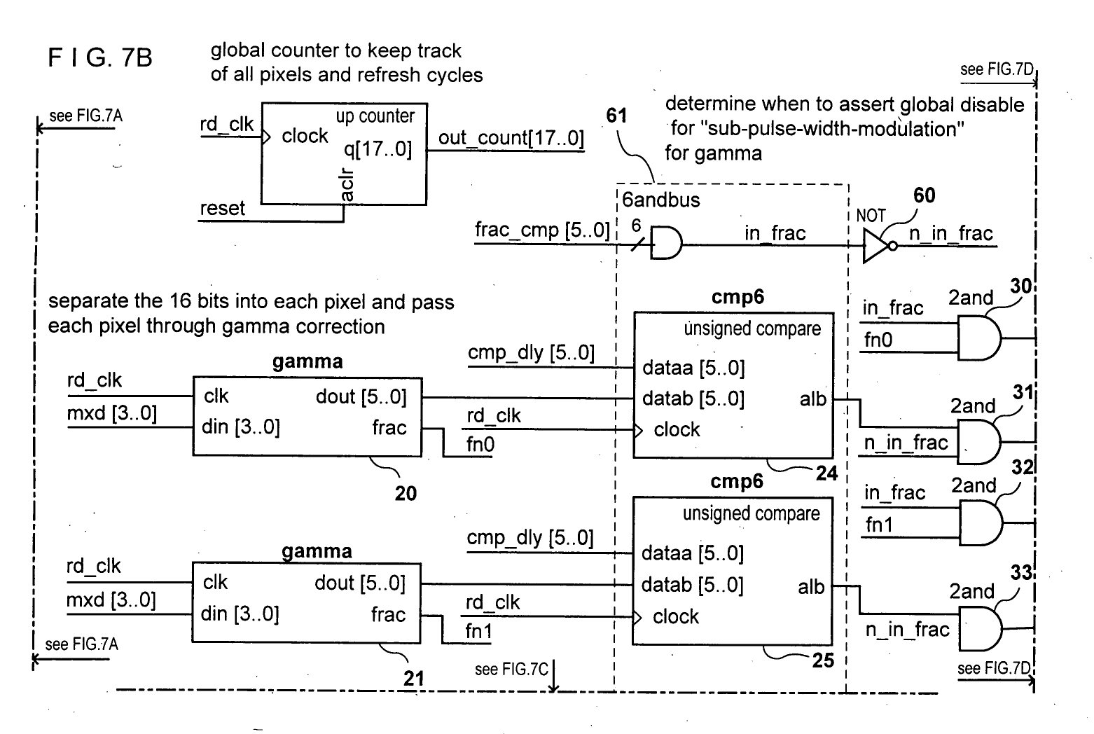

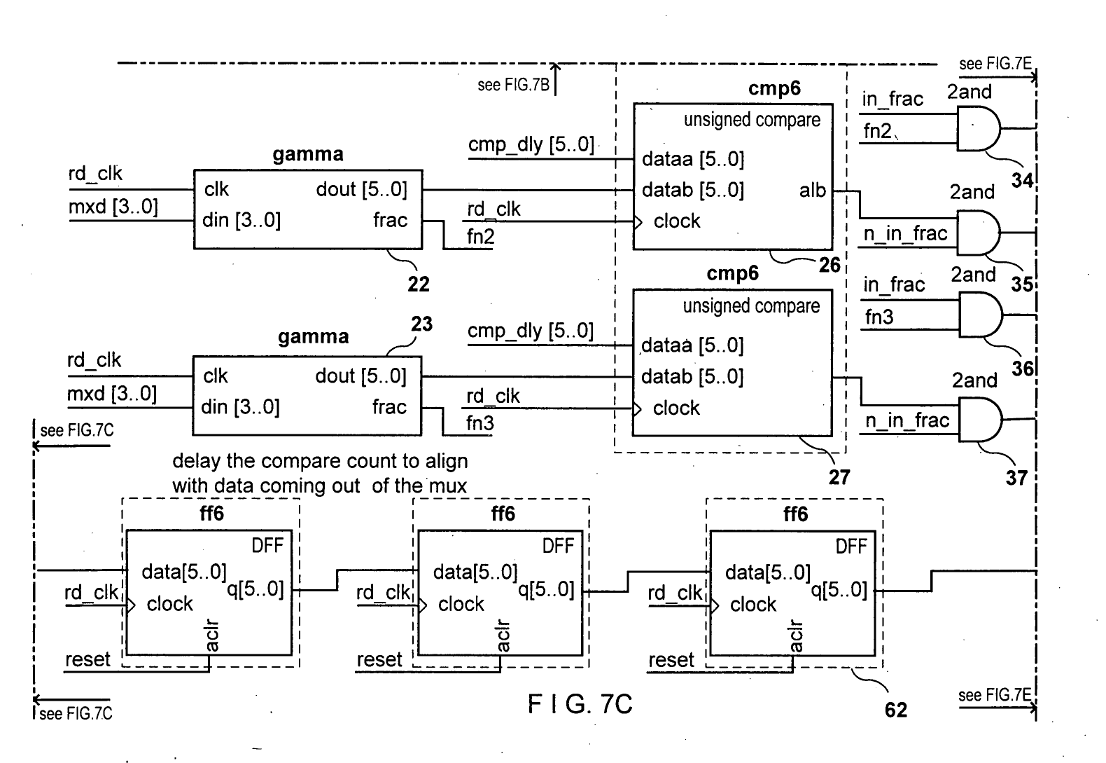

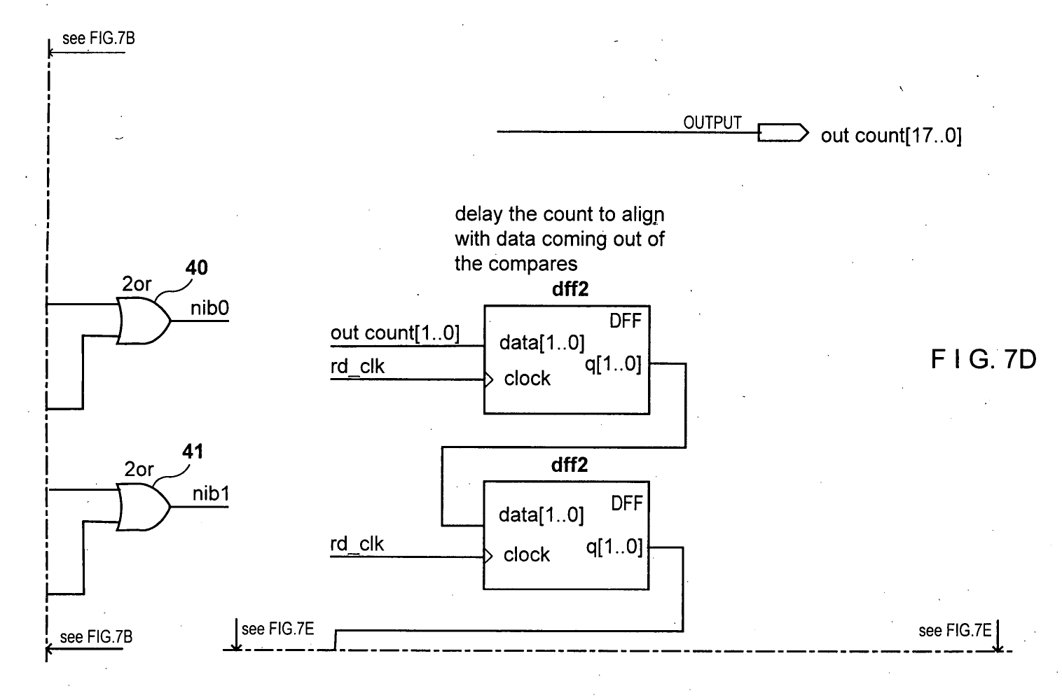

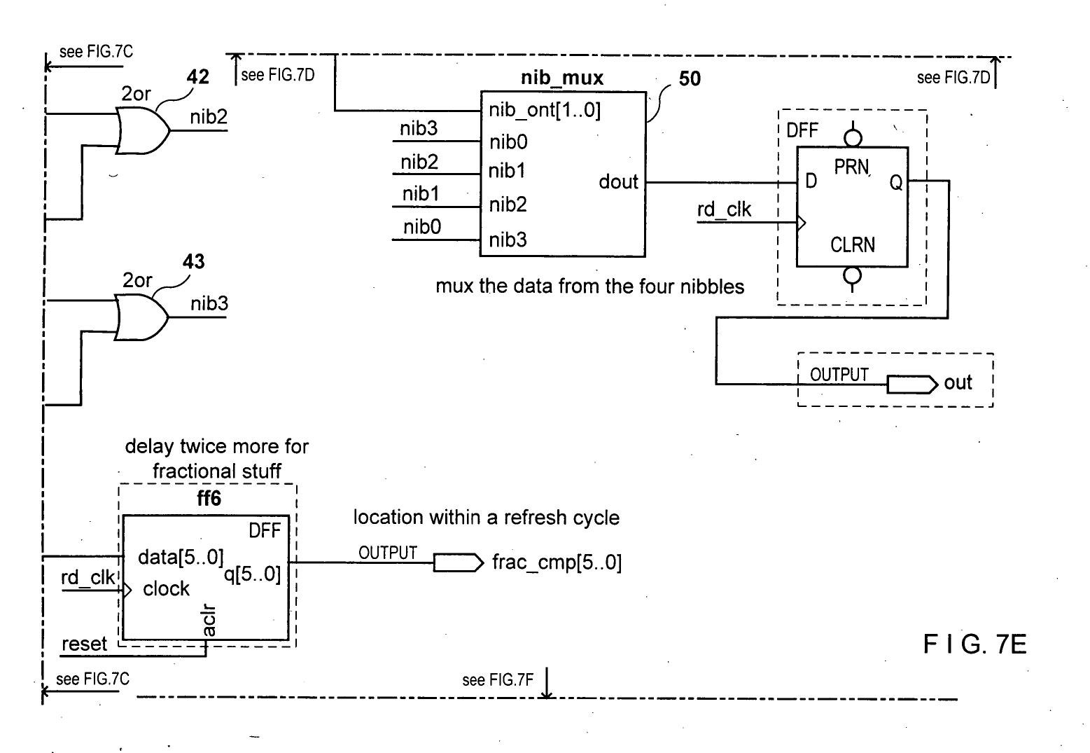

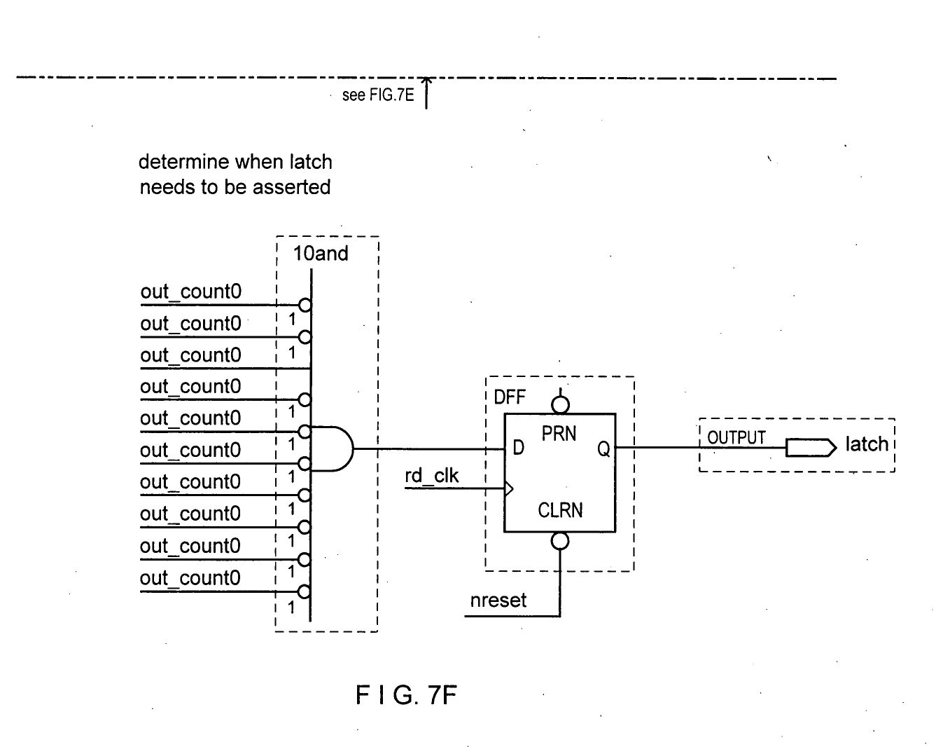

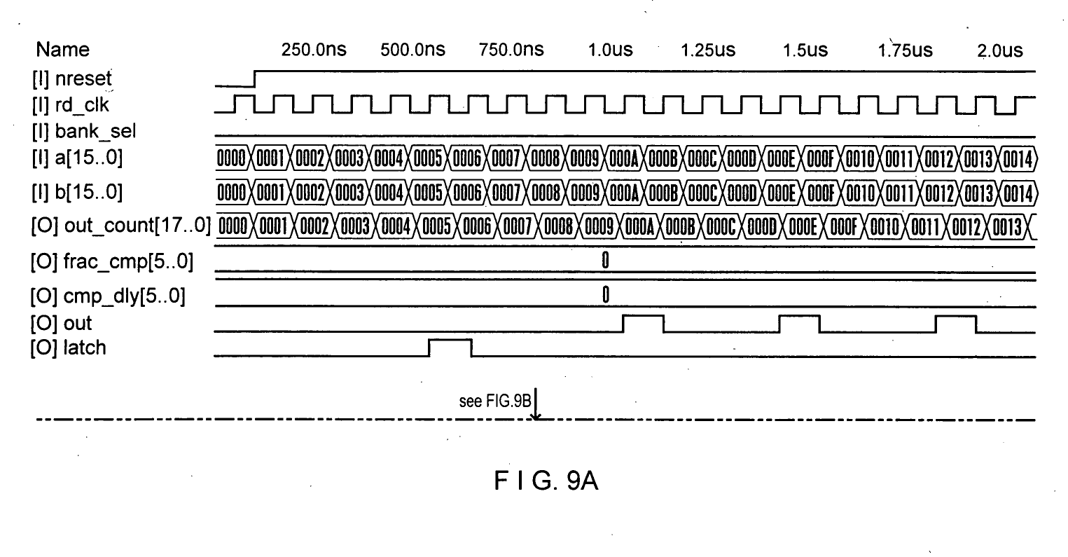

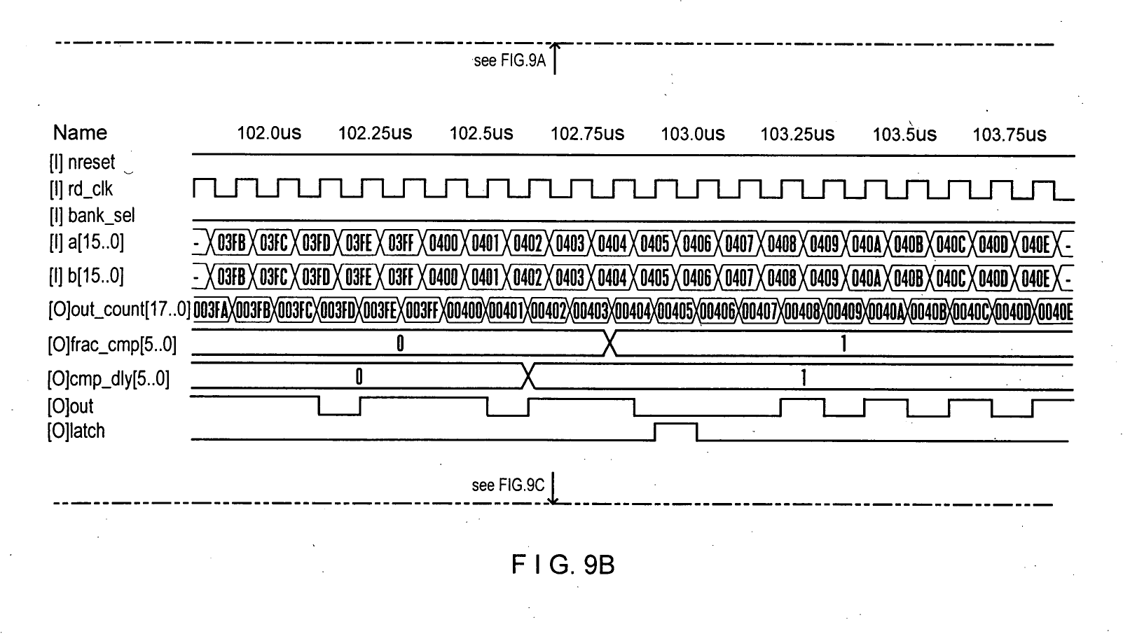

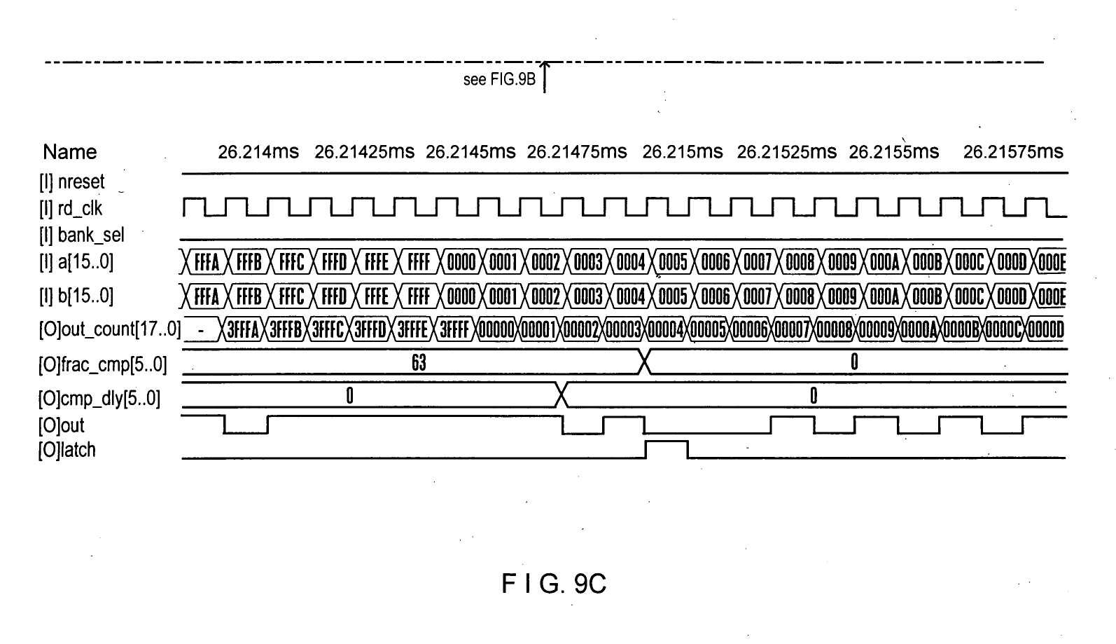

The brightness modulation block 16 is illustrated in further detail in FIG. 7 with the input/output signals illustrated in the timing diagram of FIG. 9.

FIG. 9 illustrates the following input signals;
“nreset” is the negatively asserted reset line (see FIG. 8);
“rd_clk” is the data clock;
“bank_sel” selects between the two 16-bit data inputs;
“a[15 . . . 0]” is the data input from frame bank A; and
“b[15 . . . 0]” is the data input from frame bank B.

FIG. 9 illustrates the following output signals:

“out_count[17 . . . 0]” is the bit multiplexing position, shift cycles, and refresh cycles;
“frac_cmp[5 . . . 0]” is the delayed and registered portion of out_count identifying refresh cycles; and
“cmp_dly[5 . . . 0]” is an internally used bus made external for testing only.

The modulator card 10 of FIG. 5 accepts serial RGB (red-green-blue) data, buffers the data, and converts the raw data into pulse-width-modulated (PWM) and sub-PWM data. The inputs “din_a” and “din_b” are 16-bit words that contain 4-bit brightness information for four consecutive pixels. The input “bank_sel” indicates the appropriate frame buffer from which data words should be retrieved. The input “s_data_ub” is the raw serial data received by the modulator. Likewise, “frame_in” is the frame identifier line received by the modulator. The inputs “s_data_in” and “frame_in” are required by the dimming, module to capture the dimming byte from the incoming data stream's header.

In dimming block 14 as illustrated in FIG. 6, each refresh cycle is logically divided into two parts for the fractional gamma bit. Each of those half cycles is divided further and pulse-width modulates at a faster rate for dimming. The “frame” signal is monitored and used to resynchronize the modulation. The “dimming byte” is also captured from the incoming data stream in order to determine how much dimming is required. The “frame” signal is also required for this capture.

In the brightness modulation block 16 as shown in context in FIG. 5 and shown in FIG. 7, two 16-bit words (illustrated as din_a[15 . . . 0] and din_b[15 . . . 0] in FIG. 5 and a[15 . . . 0] and b[15 . . . 0] in FIG. 7) are accessed from two banks of memory serving as frame buffers. The input “bank_sel” is used to multiplex between the frame buffers. The 16-bit words include four brightness bits for each of four consecutive pixels and are therefore broken up into four 4-bit data strings and sent to tour gamma tables 20, 21, 22, 23 working in parallel. The gamma tables 20, 21, 22, 23 each produce a 6-bit gamma corrected binary value “dout[5 . . . 0]38 and a single sub-pwm bit “frac” that is to be translated into a single fractional bit. The 6-bit gamma corrected binary values “dout[5 . . . 0]” are input into the “datab[5 . . . 0]” inputs of comparators 24, 25, 26, 27 and compared with global brightness counters “cmp_dly(5 . . . 0)” input into “dataa(5 . . . 0)” of comparators 24, 25, 26, 27. The result of the comparison, the “alb” output of comparators 24, 25, 26, 27, is used to determine if an individual pixel is to be turned on or off for a shift cycle during pulse-width-modulation. The series of AND-gates 30, 31, 32, 33, 34, 35, 36, 37 and OR-gates 40, 41, 42, 43 are configured such that the comparisons, or “alb” values, of comparators 24, 25, 26, 27 are output as “nib0”, “nib1”, “nib2” and “nib3” when “n_in_frac” is 1 (and “in_frac” is 0), and such that the fractional bit values “frac” of gamma tables 20, 21, 22, 23 (that is “fn0”, “fn1”, “fn2” and “fn3”) are output as “nib0”, “nib1”, “nib2” and “nib3” when “in_frac” is 1 (and “n_in_frac” is 0).

The value of “in_frac” is set to 1 (and inverted by inverter 60 to obtain “n_in_frac”) when 6-way AND-gate 61 determines that all values of “frac_cmp(5 . . . 0)” are equal to one, as generated by shift register 62 which counts the out_count(15 . . . 10)” values which identify the location within the refresh cycle. This value of “in_frac” and the inverted value “n_in_frac” determine when to assert the global disable for sub-pulse-width-modulation for gamma correction.

The values of nib0”, “nib1”, “nib2” and “nib3” are then multiplexed into an output word by multiplexer 50. The output word is communicated to display 100.

Thus the several aforementioned objects and advantages are most effectively attained. Although a single preferred embodiment of the invention has been disclosed and described in detail herein, it should be understood that this invention is in no sense limited thereby and its scope is to be determined by that of the appended claims.

1. A method of driving an electronic display including a plurality of display elements, including the steps of:
dividing a refresh cycle into a plurality of shift cycles;
driving the display elements of said plurality for a number of shift cycles chosen from said plurality of shift cycles, said number being determined by the intensity of a color sought to be displayed in the display elements; and
disabling the electronic display for a fraction of a subset of said plurality of shift cycles in order to provide an increased number of possible intensities of the color sought to be displayed thereby providing a perceived dimming of the color sought to be displayed, wherein said fraction is greater than zero and less than one and wherein said subset is at least one shift cycle.

2. The method of claim 1 wherein said display elements are light emitting diodes.

3. The method of claim 2 wherein said step of driving the display elements applies substantially constant current to said display elements during said number of shift cycles during which said display elements are driven and the display is not disabled.

4. An electronic display including a plurality of display elements, comprising:
means for dividing a refresh cycle into a plurality of shift cycles;
means for driving the display elements of said plurality for a number of shift cycles chosen from said plurality of shift cycles, said number being determined by the intensity of a color sought to be displayed in the display elements; and
means for disabling the electronic display for a fraction of a subset of said plurality of shift cycles in order to provide an increased number of possible intensities of the color sought to be displayed thereby providing a perceived dimming of the color sought to be displayed, wherein said fraction is greater than zero and less than one and wherein said subset is at least one shift cycle.

5. The electronic display of claim 4 wherein said display elements are light emitting diodes.

6. The electronic display of claim 5 wherein said means for driving the display elements applies substantially constant current to said display elements during said number of shift cycles during which said display elements are driven and the display is not disabled.

7. A method of pulse-width-modulation for driving a display which includes the step of driving a refresh cycle into a plurality of shift cycles and further includes the step of disabling the display for a portion of at least one shift cycle, said portion being greater than zero and less than one.

8. The method of claim 7 wherein said display includes a plurality of light emitting diodes.

9. The method of claim 8 wherein said light emitting diodes are driven by modulating between a substantially constant current and a zero current, said shift cycles providing a period of modulation.
